(19) United States
(12) Patent Application Publication
(10) Pub. No.: US 2011/0130037 A1
(43) Pub. Date: Jun. 2, 2011

(54) CAMERA MODULE SOCKET

(76) Inventor: CHIN-CHOU WANG, Tu-Cheng City (TW)

(21) Appl. No.: 12/626,910

(22) Filed: Nov. 29, 2009

(51) Int. Cl. H01R 13/648

(52) U.S. Cl. 439/607.01

(57) ABSTRACT

A camera module socket for receiving a camera module which plates a metal coating around an outer periphery thereof includes an insulating housing defining a receiving chamber for receiving a lower portion of the camera module, a plurality of conductive terminals received in the insulating housing, a metallic shell encircling the insulating housing, and a shielding cover. The shielding cover has top board which defines a through hole at a middle thereof for allowing a top portion of the camera module exposed therefrom, and a plurality of side boards extended downwardly from side edges of the top board. The shielding cover has at least one elastic arm bent into an inner thereof from the corresponding side board for elastically abutting against the camera module and electrically connected with the metal coating, and at least one resistant tab formed at the corresponding side board for pressing against metallic shell.

### BACKGROUND OF THE INVENTION

1. Field of the Invention

The present invention relates to a camera module socket, and more particularly to a camera module socket capable of preventing a camera module from falling off and also protecting the camera module from EMI.

2. The Related Art

Because of the development of wireless communication and the rapid revolution in high technology, portable electronic products, such as mobile phones, PDAs and notebook computers, are assembled with different electronic additional-modules such as camera modules for taking pictures and satisfying desires of consumers. Correspondingly, camera module sockets spring up for the camera modules.

In generally, a conventional camera module socket includes an insulating housing defining a receiving chamber therein for receiving a camera module, a plurality of conductive terminals received in the insulating housing, and a shielding shell encircling the insulating housing. The shielding shell has at least one grounding pin bent and extended into the receiving chamber for elastically abutting against the camera module and protecting the camera module from EMI.

However, the grounding pin can help to protect the camera module from EMI, but on the other hand, the grounding pin yet applies a resilience force to the camera module when the camera module is assembled to the receiving chamber, thus the camera module may be received in the receiving chamber unstably and would likely fall off the insulating housing. In view of the result, it is desirable to have a camera module socket capable of preventing a camera module from falling off and also protecting the camera module from EMI to overcome the problem encountered with the prior art.

### SUMMARY OF THE INVENTION

It is an object of the present invention to provide a camera module socket capable of preventing a camera module from falling off and also protecting the camera module from EMI. In order to achieve above-mentioned object, the camera module socket of the present invention is adapted for receiving a camera module which plates a metal coating around an outer periphery thereof. The camera module socket includes an insulating housing defining a receiving chamber for receiving a lower portion of the camera module, a plurality of conductive terminals received in the insulating housing, a metallic shell encircling the insulating housing, and a shielding cover. The shielding cover has a top board which defines a through hole at a middle thereof, and a plurality of side boards extended downwardly from side edges of the top board. The top board covers on the camera module with a top portion of the camera module exposed from the through hole. The side boards encircle the metallic shell and the camera module. The shielding cover has at least one elastic arm bent into an inner thereof from the corresponding side board for elastically abutting against the camera module and electrically connected with the metal coating, and at least one resistant tab formed at the corresponding side board for pressing against metallic shell.

As described above, the shielding cover covers the camera module, which not only prevents the camera module from falling off the insulating housing, but also protects the camera module from EMI by means of the elastic arms elastically abutting against the camera module and electrically connected with the metal coating, and the resistant tabs tightly pressing against the metallic shell.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a camera module socket in accordance with the present invention;

FIG. 2 is an exploded view of the camera module socket shown in FIG. 1;

FIG. 3 is a perspective view showing a camera module assembled to the camera module socket before a shielding cover covers the camera module; and

FIG. 4 is a perspective view showing the camera module assembled to the camera module socket after the shielding cover covers the camera module.

### DETAILED DESCRIPTION OF THE PREFERRED EMBODIMENT

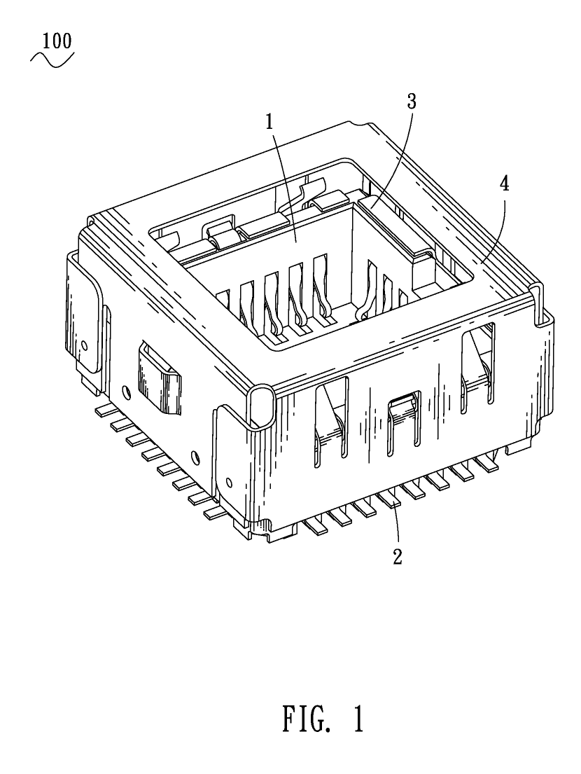

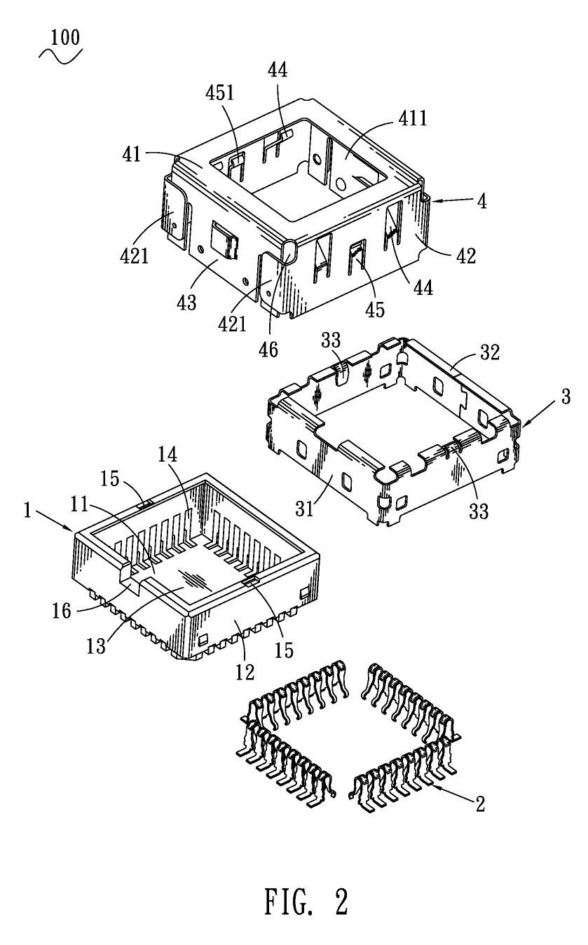

With reference to FIGS. 1 and 2, a camera module socket 100 according to the present invention includes an insulating housing 1, a plurality of conductive terminals 2 received in the insulating housing 1, a metallic shell 3 encircling the insulating housing 1 and a shielding cover 4 covering the metallic shell 3.

The insulating housing 1 has a flat bottom wall 11 and four side walls 12 respectively extended upwardly from four sides of the bottom wall 11 to surround a receiving chamber 13 therebetween. Each of the side walls 12 defines a plurality of terminal grooves 14 at a lower position thereof for receiving the conductive terminals 2. Two opposite side walls 12 each defines an engaging hole 15 at a top surface thereof. One of another two opposite side walls 12 defines a location gap 16 at a top position thereof.

The metallic shell 3 has four side plates 31 connected to each other to form a hollow square or rectangle. The side plates 31 have a plurality of rim portions 32 extended inwardly from top edges thereof. Two opposite side plates 31 further define a pair of engaging portions 33 bent inwardly and extended downwardly from the corresponding top edges thereof. The metallic shell 3 is assembled in a downward direction to encircle the insulating housing 1. The four side plates 31 wrap around the four side walls 12. The rim portions 32 press on the top surfaces of the side walls 12. The engaging portions 33 are buckled into the corresponding engaging holes 15.

The shielding cover 4 has a top board 41 which defines a through hole 411 at a middle thereof. Four side edges of the top board 41 extend downwardly to form two opposing first side boards 42 and two opposing second side boards 43. Each two adjacent side boards 42, 43 are apart from each other to define a gap 46 therebetween. Each first side board 42 has a pair of flap portions 421 bent from both opposite ends thereof to show a substantially L shape and attached to outsides of the neighboring second side boards 43. Furthermore, each first side board 42 has a pair of elastic arms 44 bent into an inner of the shielding cover 4, and a resistant tab 45 disposed between the pair of elastic arms 44 with an inward curved end 451 thereof protruded into the inner of the shielding cover 4.

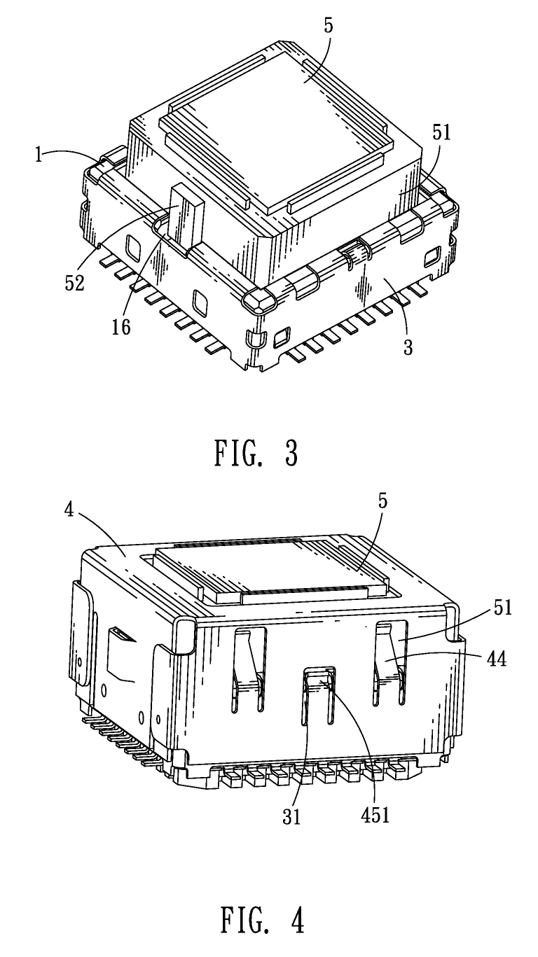

Referring to FIGS. 3 and 4, a camera module 5 received by the camera module socket 100 plates a metal coating 51 around an outer periphery thereof and has a projection 52 provided at one side thereof. The camera module 5 is assembled in the receiving chamber 13 with the projection 52 disposed in the location gap 16. After that, the shielding cover 4 is brought to cover the camera module 5 and the metallic shell 3. The top board 41 covers on the camera module 5 with a top portion of the camera module 5 exposed from the though hole 411. The elastic arms 44 are elastically abutting against the camera module 5 and electrically connected with the metal coating 51. The curved ends 451 of the resistant tabs 45 tightly press against the corresponding side plates 31 of the metallic shell 3.

When the camera module socket 100 is mounted on a printed circuit board (not shown), the camera module 5 can be protected from EMI because the shielding cover 4 covers the camera module 5 with the elastic arms 44 electrically connected with the metal coating 51 and the curved ends 451 of the resistant tabs 45 pressing against the metallic shell 3.

As described above, the shielding cover 4 covers the camera module 5, which not only prevents the camera module 5 from falling off the insulating housing 1, but also protects the camera module 5 from EMI by means of the elastic arms 44 elastically abutting against the camera module 5 and electrically connected with the metal coating 51, and the curved ends 451 of the resistant tabs 45 tightly pressing against the metallic shell 3.

What is claimed is:

1. A camera module socket for receiving a camera module which plates a metal coating around an outer periphery thereof, comprising:
an insulating housing, the insulating housing defining a receiving chamber therein for receiving a lower portion of the camera module;
a plurality of conductive terminals received in the insulating housing;
a metallic shell encircling the insulating housing; and
a shielding cover, the shielding cover having a top board which defines a through hole at a middle thereof, and a plurality of side boards extended downwardly from side edges of the top board, the top board being covered on the camera module with a top portion of the camera module exposed from the through hole, the side boards encircling the metallic shell and the camera module, the shielding cover having at least one elastic arm bent into an inner thereof from the corresponding side board for elastically abutting against the camera module and electrically connected with the metal coating, and at least one resistant tab formed at the corresponding side board for pressing against metallic shell.

2. The camera module socket as claimed in claim 1, wherein the side board includes two opposing first side boards and two opposing second side boards, the elastic arm and the resistant tab are formed at the first side board.

3. The camera module socket as claimed in claim 2, wherein each of the first side boards includes a pair of the elastic arms and one resistant tab disposed between the pair of elastic arms.

4. The camera module socket as claimed in claim 2, wherein each first side board has a pair of flap portions bent from both opposite ends thereof to show a substantially L shape and attached to outsides of the neighboring second side boards.

5. The camera module socket as claimed in claim 1, wherein two opposite side walls of the insulating housing each defines an engaging hole at a top surface thereof, two opposite side plates of the metallic shell define a pair of engaging portions bent inwardly and extended downwardly from top edges thereof for being buckled into the corresponding engaging holes.

6. The camera module socket as claimed in claim 1, wherein side plates of the metallic shell have a plurality of rim portions extended inwardly from top edges thereof for pressing on top surfaces of side walls of the insulating housing.
